(19) United States
(12) Patent Application Publication
(10) Pub. No.: US 2023/0330534 A1
(43) Pub. Date: Oct. 19, 2023

(54) METHOD AND APPARATUS FOR CONTROLLING OPENING OPERATIONS IN VIRTUAL SCENE

(71) Applicant: Tencent Technology (Shenzhen) Company Limited, Shenzhen (CN)

(72) Inventor: Jieqi XIE, Shenzhen (CN)

(73) Assignee: Tencent Technology (Shenzhen) Company Limited, Shenzhen (CN)

(21) Appl. No.: 18/211,844

(22) Filed: Jun. 20, 2023

Related U.S. Application Data
(63) Continuation of application No. PCT/CN2022/125252, filed on Oct. 14, 2022.

(30) Foreign Application Priority Data
Dec. 15, 2021 (CN) 202111536917.X

(51) Int. Cl. A63F 13/533; G06F 3/0487

(52) U.S. Cl. CPC A63F 13/533; G06F 3/0487

(57) ABSTRACT

A method and apparatus for controlling opening operations in a virtual scene are provided. The method includes: presenting a target virtual object and an opening control of the virtual scene; where the opening control is associated with at least two opening operations, and the opening operations are interaction preparation operations before the target virtual object interacts with other virtual objects; in response to a trigger operation for the opening control, executing the at least two opening operations; and in response to completion of execution of the at least two opening operations, canceling presentation of the opening control, and presenting a battle interface, the battle interface being used for the target virtual object to interact with the other virtual objects in a battle.

### RELATED APPLICATION

This application is a continuation application of PCT Patent Application No. PCT/CN2022/125252, filed on Oct. 14, 2022, which claims priority to Chinese Patent Application No. 202111536917.X, filed on Dec. 15, 2021, wherein the content of the above-referenced applications is incorporated herein by reference in its entirety.

### FIELD OF THE TECHNOLOGY

This disclosure relates to a human-computer interaction technology, and in particular, to a method and an apparatus for controlling opening operations in a virtual scene, a device, a computer-readable storage medium and a computer program product.

### BACKGROUND OF THE DISCLOSURE

A display technology based on graphics processing hardware extends a channel for sensing the environment and acquiring information. Especially, a technology for displaying a virtual scene, capable of achieving diversified interactions between virtual objects controlled by users or artificial intelligence according to actual application requirements, has an application in various typical scenes, for example, in virtual scenes of simulation, games and the like, to enable the battle process between the virtual objects to be simulated.

In some virtual scene applications, a player needs to execute a series of identical opening operations each time they open a game, such as tapping multiple novice prompts, tapping a prop control to purchase virtual props, or lighting up multiple virtual skills of roles, etc. If the player mistakenly operates or misses an operation, then unfavorable opening would be caused. In order to achieve a favorable opening effect, the player needs to execute the opening operations one by one multiple times, resulting in low human-computer interaction efficiency.

### SUMMARY

Provided in embodiments of this disclosure are a method and an apparatus for controlling opening operations in a virtual scene, a device, a computer-readable storage medium and a computer program product, which may improve execution efficiency of the opening operations.

Provided in an embodiment of this disclosure is a method for controlling opening operations in a virtual scene, including:
presenting a target virtual object and an opening control of the virtual scene, the opening control being associated with at least two opening operations, and the opening operations being interaction preparation operations before the target virtual object interacts with another virtual object;
in response to a trigger operation for the opening control, executing the at least two opening operations; and
in response to completion of execution of the at least two opening operations, canceling presentation of the opening control, and presenting a battle interface, the battle interface being for the target virtual object to interact with the another virtual object in a battle.

Provided in an embodiment of this disclosure is an apparatus for controlling opening operations in a virtual scene, including a memory operable to store computer-readable instructions and a processor circuitry operable to read the computer-readable instructions. When executing the computer-readable instructions, the processor circuitry is configured to:
present a target virtual object and an opening control of the virtual scene, the opening control being associated with at least two opening operations, and the opening operations being interaction preparation operations before the target virtual object interacts with another virtual object;
in response to a trigger operation for the opening control, execute the at least two opening operations; and
in response to completion of execution of the at least two opening operations, cancel presentation of the opening control, and present a battle interface, the battle interface being for the target virtual object to interact with the another virtual object in a battle.

Provided in an embodiment of this disclosure is non-transitory machine-readable media, having instructions stored on the machine-readable media. When being executed, the instructions are configured to cause a machine to:
present a target virtual object and an opening control of the virtual scene, the opening control being associated with at least two opening operations, and the opening operations being interaction preparation operations before the target virtual object interacts with another virtual object;
in response to a trigger operation for the opening control, execute the at least two opening operations; and
in response to completion of execution of the at least two opening operations, cancel presentation of the opening control, and present a battle interface, the battle interface being for the target virtual object to interact with the another virtual object in a battle.

The embodiments of this disclosure have the following beneficial effects.

By applying the embodiments of this disclosure, since the opening control is associated with the plurality of opening operations, all the opening operations associated with the opening control may be executed through a single trigger operation for the opening operations. Compared with the related technology in which the interaction controls for each of the opening operation are tapped one by one to execute the corresponding opening operation, an operation path of opening in a virtual scene is greatly shortened, the number of operations required to complete a plurality of opening operations required for opening is reduced, one-tap opening for the virtual scene is achieved, and execution efficiency of the opening operations and human-computer interaction efficiency are improved.

### BRIEF DESCRIPTION OF THE DRAWINGS

FIG. 1A is a schematic diagram of a scene in which a method for controlling opening operations in a virtual scene according to an embodiment of this disclosure is applied.

FIG. 1B is a schematic diagram of a scene in which a method for controlling opening operations in a virtual scene according to an embodiment of this disclosure is applied.

FIG. 2 is a schematic structural diagram of a terminal device 400 according to an embodiment of this disclosure.

FIG. 3 is a schematic flow diagram of a method for controlling opening operations in a virtual scene according to an embodiment of this disclosure.

FIG. 4 is a schematic diagram of associated settings of an opening control according to an embodiment of this disclosure.

FIG. 5 is a schematic diagram showing touch progress prompt information according to an embodiment of this disclosure.

FIG. 6 is a schematic diagram showing touch upper-limit prompt information according to an embodiment of this disclosure.

FIG. 7 is a schematic diagram of settings of an opening control according to an embodiment of this disclosure.

FIG. 8 is a schematic diagram of settings of an opening control according to an embodiment of this disclosure.

FIG. 9 is a schematic diagram of settings of an opening control according to an embodiment of this disclosure.

FIG. 10 is a schematic diagram of number switching according to an embodiment of this disclosure.

FIG. 11 is a schematic diagram of number switching according to an embodiment of this disclosure.

FIG. 12 is a schematic diagram of settings of an opening control according to an embodiment of this disclosure.

FIG. 13 is a schematic diagram of settings of an opening control according to an embodiment of this disclosure.

FIG. 14 is a schematic diagram of settings of an opening control according to an embodiment of this disclosure.

FIG. 15 is a schematic diagram presenting opening operations according to an embodiment of this disclosure.

FIG. 16 is a schematic diagram displaying opening operations according to an embodiment of this disclosure.

FIG. 17 is a schematic flow diagram of a method for setting an opening control in a virtual scene according to an embodiment of this disclosure.

### DESCRIPTION OF EMBODIMENTS

To make the objectives and advantages of this disclosure clearer, the following will describe this disclosure in further detail in conjunction with the accompanying drawings. The described embodiments are not to be considered as a limitation to this disclosure. All other embodiments obtained by a person of ordinary skill in the art without creative efforts shall fall within the protection scope of this disclosure.

In the following description, “some embodiments” involved describe subsets of all possible embodiments, but it may be understood that, “some embodiments” may be the same subset or different subsets of all the possible embodiments, and may be combined with each other without conflict.

In the following description, terms “first, second, third, fourth . . . ” involved are used for distinguishing only similar objects, and do not represent particular ordering for the objects. It may be understood that, “first, second, third, fourth . . . ” may be interchanged in a particular order or sequence where permitted, such that the embodiments of this disclosure described herein may be implemented in an order other than that illustrated or described herein.

Unless otherwise defined, all technical and scientific terms used herein have the same meanings as those commonly understood by a person skilled in the art to which this disclosure belongs. Terms used herein are merely for the purpose of describing the embodiments of this disclosure, and are not intended to limit this disclosure.

Before the embodiments of this disclosure are described in detail, a description is made of nouns and terms involved in the embodiments of this disclosure, and the nouns and terms involved in the embodiments of this disclosure are applicable to the following explanations.
1) “client” refers to an application that runs in a terminal to provide various services, for example, a video playback client, a game client, etc.
2) “in response to” is used for representing a condition or state on which an operation executed depends. One or more operations executed may be real-time or may have a set delay when the dependent condition or state is met. There is no limitation on the order of execution of the plurality of operations executed, unless otherwise specified.
3) “virtual scene” refers to a virtual scene displayed (or provided) when the disclosure runs on the terminal. The virtual scene may be a simulation environment of the real world, a semi-simulation and semi-fictional virtual environment, or a purely fictional environment. The virtual scene may be any one of a two-dimensional virtual scene, a 2.5-dimensional virtual scene, or a three-dimensional virtual scene. Dimensions of the virtual scene are not limited in the embodiments of this disclosure. For example, the virtual scene may include sky, land, sea, etc. The land may include environmental elements such as a desert and a city. A user may control a virtual object to move in the virtual scene.
4) “virtual object” refers to an image of each person and object that may interact in the virtual scene, or a movable object in the virtual scene. The movable object may be a virtual character, a virtual animal, a cartoon character, or the like, such as a character, an animal, or the like displayed in the virtual scene. The virtual object may be a virtual image in the virtual scene that is used for representing a user. The virtual scene may include a plurality of virtual objects. Each virtual object has its own shape and volume in the virtual scene, and occupies part of the space in the virtual scene.
5) “scene data” represents characteristic data in the virtual scene. For example, it may include a position of the virtual object in the virtual scene, or may further include a time required to wait for various functions configured in the virtual scene (depending on the number of times that the same function may be used within a specific time). It may further represent an attribute value, such as a health value and a magic value, of each state of the virtual object.

Provided in embodiments of this disclosure are a method and an apparatus for controlling opening operations in a virtual scene, an electronic device, a computer-readable storage medium and a computer program product, which may improve opening efficiency. To facilitate an easier understanding of the method for controlling opening operations in a virtual scene according to an embodiment of this disclosure, an exemplary scene, in which the method for controlling opening operations in a virtual scene according to the embodiment of this disclosure is implemented, is firstly described. A virtual scene according to the embodiment of this disclosure may be output based on a terminal device or a server alone, or cooperatively output based on the terminal device or the server.

In some embodiments, the virtual scene may be a picture presented in a simulation. In some other embodiments, the virtual scene may further be an environment for game roles to interact, such as for game roles to virtually battle in the virtual scene. By controlling actions of the game roles, both sides may interact in the virtual scene, thereby enabling a user to relieve the stress of life in the process of a game.

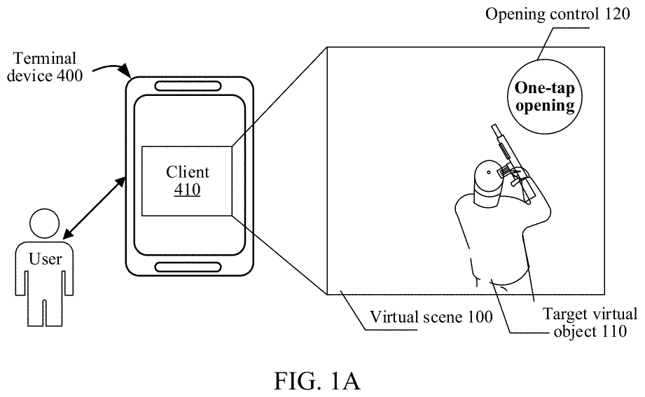

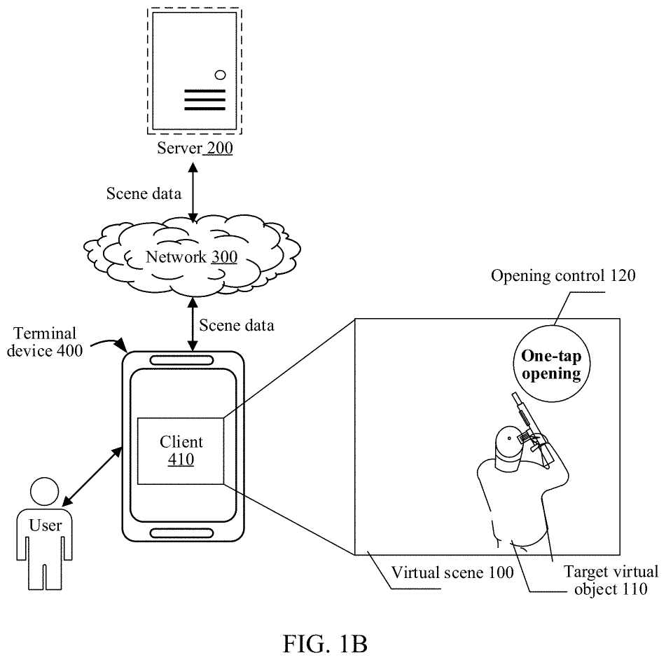

In one implementation scene, referring to FIG. 1A, it is a schematic diagram of a scene in which a method for controlling opening operations in a virtual scene according to an embodiment of this disclosure is applied. In this application scene, the method for controlling opening operations in a virtual scene according to the embodiment of this disclosure completely relies on a terminal device. Computation of data related to the virtual scene 100 may be completed using computing power of the graphics processing hardware of the terminal device 400. For example, as for games in a stand-alone/off-line mode, output of the virtual scene is completed through different types of terminal devices 400, such as a smartphone, a tablet computer and a virtual reality/augmented reality device. As an example, the types of the graphics processing hardware include a central processing unit (CPU) and a graphics processing unit (GPU).

When a visual perception of the virtual scene 100 is formed, the terminal device 400 computes data required for display and completes loading, parsing and rendering of the displayed data through graphics computing hardware. Video frames capable of forming the visual perception for the virtual scene are output on the graphics output hardware. For example, two-dimensional video frames are presented on a display screen of a smartphone, or video frames achieving a three-dimensional display effect are projected on lenses of augmented reality/virtual reality glasses. In addition, in order to enrich a perception effect, the terminal device 400 may also form one or more of auditory perception, tactile perception, motion perception and taste perception by means of different hardware.

As an example, a client 410 (e.g., a stand-alone game application) runs on the terminal device 400. A virtual scene including role playing is output in the process of running the client 410. The virtual scene may be an environment for the game roles to interact such as a plain, a street, a valley, etc., for the game roles to battle. The virtual scene includes a target virtual object 110 and an opening control 120. The virtual object 110 may be a game role controlled by a user (also known as player). That is, the target virtual object is controlled by the real user, and will move in the virtual scene in response to an operation of the real user for a controller (including a touch screen, a voice-activated switch, a keyboard, a mouse, a joystick, etc.). For example, when the real user moves the joystick to the left, the target virtual object 110 will move to the left in the virtual scene, and may also stay stationary in situ, leap, and use various functions (e.g., skills and props). The opening control 120 is associated with at least two opening operations which are interaction preparation operations executed before the target virtual object interacts with other virtual objects.

For instance, the terminal device 400 presents the target virtual object 110 and opening control 120 of the virtual scene 100. The opening control 120 is associated with at least two opening operations which are interaction preparation operations before the target virtual object interacts with other virtual objects. In response to a trigger operation for the opening control 120, the above-mentioned at least two opening operations are executed. In response to completion of execution of the at least two opening operations, presentation of the opening control 120 is canceled, and a battle interface is presented. The battle interface is used for the target virtual object 110 to interact with the other virtual objects in a battle in the virtual scene 100. As such, through a single trigger operation for the opening control, all the opening operations associated with the opening control may be executed to complete all the interaction preparation operations. Compared with the related technology in which the interaction controls for each of the opening operation are tapped one by one to execute the corresponding opening operation, an operation path of opening in the virtual scene is greatly shortened, the number of operations required to complete the plurality of opening operations required for opening is reduced, one-tap opening for the virtual scene is achieved, and human-computer interaction efficiency and execution efficiency of the opening operations are improved.

In another implementation scene, referring to FIG. 1B, it is a schematic diagram of a scene in which a method for controlling opening operations in a virtual scene according to an embodiment of this disclosure is applied to a terminal device 400 and a server 200. In this application scene, computation of data related to the virtual scene is completed using computing power of the server 200, and the virtual scene is output on the terminal device 400. Taking forming a visual perception of the virtual scene 100 as an example, the server 200 computes and sends displayed data (e.g., scene data) related to the virtual scene to the terminal device 400 through a network 300. The terminal device 400 loads, parses and renders the computed displayed data relying on the graphics computing hardware, and outputs the virtual scene relying on graphics output hardware to form the visual perception. For example, two-dimensional video frames may be presented on a display screen of a smartphone, or video frames achieving a three-dimensional display effect are projected on lenses of augmented reality/virtual reality glasses. It may be understood that, a perception for the form of the virtual scene may be output by means of the corresponding hardware of the terminal device 400. For example, a microphone is used for forming auditory perception, a vibrator is used for forming tactile perception, and so on.

As an example, a client 410 (e.g., a stand-alone game application) runs on the terminal device 400. A virtual scene including role playing is output in the process of running the client 410. The virtual scene may be an environment for the game roles to interact such as a plain, a street, a valley, etc., for the game roles to battle. The virtual scene includes a target virtual object 110 and an opening control 120. The virtual object 110 may be a game role controlled by a user (also known as player). That is, the target virtual object is controlled by the real user, and will move in the virtual scene in response to an operation of the real user for a controller (including a touch screen, a voice-activated switch, a keyboard, a mouse, a joystick, etc.). For example, when the real user moves the joystick to the left, the target virtual object 110 will move to the left in the virtual scene, and may also stay stationary in situ, leap, and use various functions (e.g., skills and props). The opening control 120 is associated with at least two opening operations which are interaction preparation operations executed before the target virtual object interacts with other virtual objects.

For instance, the terminal device 400 presents the target virtual object 110 and opening control 120 of the virtual scene 100. The opening control 120 is associated with at least two opening operations which are interaction preparation operations before the target virtual object interacts with other virtual objects. In response to a trigger operation for the opening control 120, the at least two opening operations are executed. In response to completion of execution of the at least two opening operations, presentation of the opening control 120 is canceled, and a battle interface is presented. The battle interface is used for the target virtual object 110 to interact with the other virtual objects in a battle in the virtual scene 100. As such, through a single trigger operation for the opening control, all the opening operations associated with the opening control may be executed to complete all the interaction preparation operations. Compared with the related technology in which the interaction controls for each of the opening operation are tapped one by one to execute the corresponding opening operation, an operation path of opening in the virtual scene is greatly shortened, the number of operations required to complete the plurality of opening operations required for opening is reduced, one-tap opening for the virtual scene is achieved, and human-computer interaction efficiency and execution efficiency of the opening operations are improved.

In some embodiments, the terminal device 400 may implement the method for controlling opening operations in a virtual scene according to an embodiment of this disclosure by running a computer program. For example, the computer program may be a native program or software module in an operating system. It may be a native application (APP), i.e., a program that needs to be installed in the operating system to run, such as a shooting game APP (i.e., the above-mentioned client 410). It may also be an applet, i.e., a program that only needs to be downloaded into a browser environment to run. It may further be a game applet capable of being embedded into any APP. To sum up, the above-mentioned computer program may be any form of application, module or plug-in.

Taking the application being the computer program as an example, in actual implementation, the terminal device 400 has an application that supports the virtual scene installed and running thereon. The application may be any one of a first-person shooting game (FPS), a third-person shooting game, a virtual reality application, a three-dimensional map program, a simulated program or a multiplayer gunbattle survival game. The user operates the virtual object in the virtual scene to move using the terminal device 400. The movement includes, but is not limited to, at least one of adjusting a body posture, crawling, walking, running, riding, leaping, driving, picking, shooting, attacking, throwing, and building a virtual building. Schematically, the virtual object may be a virtual character, such as a simulation character role or a cartoon character role.

In some other embodiments, the embodiment of this disclosure may further implemented by means of a cloud technology. The cloud technology refers to a hosting technology that integrates a series of resources such as hardware, software, and a network within a wide area network or a local area network to compute, store, process, and share data.

The cloud technology is a general term for a network technology, an information technology, an integration technology, a management platform technology, an application technology and the like applied based on a cloud computing business mode. Resource pools can be formed for on-demand use, which is flexible and convenient. The cloud computing technology will become an important support. A back-end service of a technical network system needs a lot of computing and storage resources.

As an example, the server 200 in FIG. 1B may be an independent physical server, may also be a server cluster comprising a plurality of physical servers or a distributed system, and may further be a cloud server providing basic cloud computing services, such as a cloud service, a cloud database, cloud computing, a cloud function, cloud storage, a network service, cloud communication, a middleware service, a domain name service, a security service, a content delivery network (CDN), and a big data and artificial intelligence platform. The terminal device 400 may be a smartphone, a tablet computer, a notebook computer, a desktop computer, a smart speaker, a smartwatch, etc., but is not limited thereto. The terminal device 400 and the server 200 may be directly or indirectly connected through a wired or wireless communication way, which is not limited in the embodiment of this disclosure.

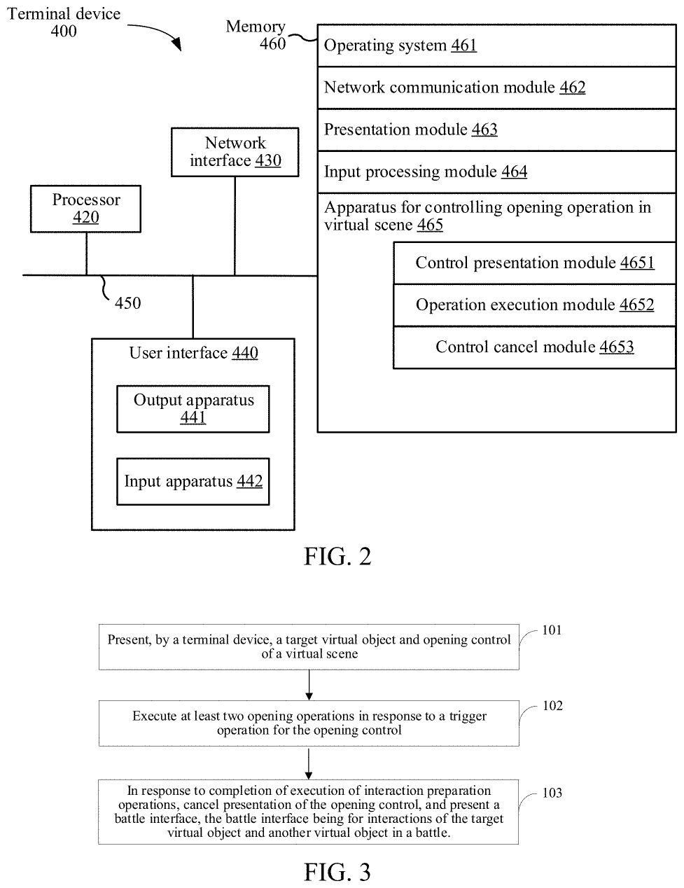

The following is a description of an electronic device implementing the above-mentioned method according to the embodiment of this disclosure. The electronic device may be the terminal device 400 shown in FIG. 1A, or the terminal device and the server shown in FIG. 1B. Taking the terminal device 400 being the electronic device as an example, referring to FIG. 2, it is a schematic structural diagram of the terminal device 400 according to an embodiment of this disclosure. The terminal device 400 shown in FIG. 2 includes: at least one processor 420, a memory 460, at least one network interface 430 and a user interface 440. All components in the terminal device 400 are coupled together through a bus system 450. It may be understood that, the bus system 450 is used for implementing connection and communication between such components. In addition to a data bus, the bus system 450 further includes a power bus, a control bus, and a state signal bus. But, for the sake of a clear description, all types of buses in FIG. 2 are marked as the bus system 450.

The processor 420 may be an integrated circuit chip with signal processing capability, such as a general-purpose processor, a digital signal processor (DSP), or other programmable logic devices, discrete gates or transistor logic devices, discrete hardware components, etc. The general-purpose processor may be a microprocessor or any conventional processor or the like.

The user interface 440 includes one or more output apparatuses 441 enabling presentation of media content, including one or more loudspeakers and/or one or more visual display screens. The user interface 440 further includes one or more input apparatuses 442, including a user interface component contributing to user input, such as a keyboard, a mouse, a microphone, a touch display screen, a camera, and other input buttons and controls.

The memory 460 may be removable, non-removable or a combination thereof. Exemplary hardware device includes a solid state memory, a hard disk drive, an optical disk drive, etc. The memory 460 may include one or more storage devices physically located away from the processor 420.

The memory 460 includes a transitory memory or non-transitory memory, and may also include both the transitory and non-transitory memories. The non-transitory memory may be a read only memory (ROM), and the transitory memory may be a random access memory (RAM). The memory 460 described in the embodiment of this disclosure is intended to include any suitable types of memories.

In some embodiments, the memory 460 can store data to support various operations. Examples of such data include a program, a module and a data structure or a subset or superset thereof, as illustrated exemplarily below.

An operating system 461 includes a system program for processing various basic system services and executing hardware-related tasks, such as a framework layer, a core library layer, a driver layer, etc., for implementing various basic businesses and processing hardware-based tasks.

A network communication module 462 is configured to access to other computing devices via one or more (wired or wireless) network interfaces 430. Exemplary network interfaces 430 include: bluetooth, wireless compatibility certification (WiFi), a universal serial bus (USB), etc.

A presentation module 463 is configured to enable presentation of information via one or more output apparatuses 441 (e.g., display screens and loudspeakers) associated with the user interface 440 (e.g., configured to operate a peripheral device and the user interface displaying content and information).

An input processing module 464 is configured to detect one or more user inputs or interactions from the one or more input apparatuses 442, and to translate the detected inputs or interactions.

In some embodiments, the apparatus for controlling opening operations in a virtual scene according to the embodiment of this disclosure may be implemented in a software. An apparatus 465 for controlling opening operations in a virtual scene stored in the memory 460 is shown in FIG. 2, and it may be software in a form of a program, a plug-in, etc., and includes the following software modules: a control presentation module 4651, an operation execution module 4652 and a control cancel module 4653. Such modules are logical, and thus may be arbitrarily combined or split according to functions they achieve. The function of each of the modules will be described below.

The term “module” (and other similar terms such as unit, submodule, etc.) refers to computing software, firmware, hardware, and/or various combinations thereof. At a minimum, however, modules are not to be interpreted as software that is not implemented on hardware, firmware, or recorded on a non-transitory processor readable recordable storage medium. Indeed “module” is to be interpreted to include at least some physical, non-transitory hardware such as a part of a processor, circuitry, or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices. The modules can be implemented in software stored in memory or non-transitory computer-readable medium. The software stored in the memory or medium can run on a processor or circuitry (e.g., ASIC, PLA, DSP, FPGA, or any other integrated circuit) capable of executing computer instructions or computer code. The modules can also be implemented in hardware using processors or circuitry on the same or different integrated circuit.

In some other embodiments, the apparatus for controlling opening operations in a virtual scene according to the embodiment of this disclosure may be implemented in a hardware. As an example, the apparatus for controlling opening operations in a virtual scene according to the embodiment of this disclosure may be a processor in form of a hardware decoding processor, which is programed to perform the method for controlling opening operations in a virtual scene according to the embodiment of this disclosure. For example, the processor in form of the hardware decoding processor may adopt one or more application specific integrated circuits (ASICs), DSPs, programmable logic devices (PLDs), complex programmable logic devices (CPLDs), field-programmable gate arrays (FPGAs), or other electronic elements.

The following will describe the method for controlling opening operations in a virtual scene according to the embodiment of this disclosure in conjunction with the accompanying drawings. The method for controlling opening operations in a virtual scene according to the embodiment of this disclosure may be performed by the terminal device or the server alone, and may also be cooperatively performed by the terminal device and the server.

Hereinafter, a description is made by taking the method according to the embodiment of this disclosure being performed by the terminal device 400 in FIG. 1A alone as an example. Referring to FIG. 3, it is a schematic flow diagram of a method for controlling opening operations in a virtual scene according to an embodiment of this disclosure. A description will be made in conjunction with the steps shown in FIG. 3.

The method shown in FIG. 3 may be performed by various forms of computer programs running on the terminal device 400. It is not limited to the above-mentioned client 410, and may further be the above-mentioned operating system 461, software module and script. Thus, the client is not to be regarded as limiting the embodiment of this disclosure.

At step 101, a target virtual object and an opening control of the virtual scene are presented on the terminal device.

Here, a client supporting the virtual scene is installed on the terminal device (i.e., the terminal). When the user opens the client on the terminal and the terminal runs the client, the terminal presents an interaction interface of the virtual scene obtained by observing the virtual scene from the perspective of the target virtual object, and presents the target virtual object and opening control of the virtual scene in the interaction interface. The user may use a virtual object of a current account to interact with other virtual objects in a battle in the virtual scene based on the interaction interface. The target virtual object is the virtual object in the virtual scene corresponding to the current user account. The user (also known as player) may control the target virtual object to interact with the other virtual objects in the virtual scene based on the interaction interface of the virtual scene. For example, the target virtual object is controlled to hold a virtual shooting prop (e.g., a virtual sniping firearm, a virtual submachine gun, a virtual shotgun, etc.) to shoot the other virtual objects. Or, the target virtual object is controlled to release a virtual skill to act on the other virtual objects. The other virtual objects are virtual objects in the virtual scene corresponding to other user accounts different from the current user account, and may be in an adversarial relationship or friendly relationship with the target virtual object.

In practical applications, when the target virtual object has just entered the virtual scene, the user needs to execute a plurality of opening operations. Said opening operations refer to interaction preparation operations before the target virtual object interacts with the other virtual objects, namely interaction preparation operations before an interaction battle in the virtual scene is opened, such as tapping novice prompt information or a prop purchase prompt, etc. If the user does not tap a control related to the novice prompt information, then the novice prompt information would always be presented in the interaction interface, which will inevitably block part of a display area of the terminal device, thus affecting the user's control of the interaction of the target virtual object in the virtual scene. Certain virtual props need to be purchased when the target virtual object has just entered the virtual scene (also known as spawn point), otherwise there are subsequent situations where they cannot be purchased. Thus, if such virtual props are not purchased before the interaction battle is opened, then the user's subsequent control of the interaction of the target virtual object in the virtual scene would be affected. An embodiment of this application provides a one-tap opening control capable of completing a plurality of opening operations once. The one-tap opening control is abbreviated as an opening control associated with at least two opening operations (i.e., interaction preparation operations). One-tap execution of the plurality of associated opening operations may be conducted through the opening control, which may improve execution efficiency of the opening operations and human-computer interaction efficiency, achieve a favorable opening effect, and enable the player to quickly enter the battle.

In some embodiments, before presenting the opening control, the terminal device may set the opening operations associated with the opening control through the following methods: presenting a setting interface for setting the opening operations associated with the opening control, and presenting, in the setting interface, an adding control for adding the opening operations; in response to a trigger operation for the adding control, presenting an adding interface of the virtual scene, and presenting at least two interaction controls in the adding interface; receiving a selection operation for a target number of interaction controls among the at least two interaction controls; and in response to a save instruction for the selection operation, determining operations corresponding to the target number of interaction controls as the at least two opening operations associated with the opening control.

Here, the target number is less than or equal to a total number of the interaction controls in the adding interface. In practical applications, the selection operation for the above-mentioned target number of interaction controls may be implemented through an operation sequence including a plurality of touch operations. That is, the above-mentioned selection operation includes a touch operation sequence for the target number of interaction controls. Each of the touch operations corresponds to an interaction control, that is, the touch operations correspond to the interaction controls one to one.

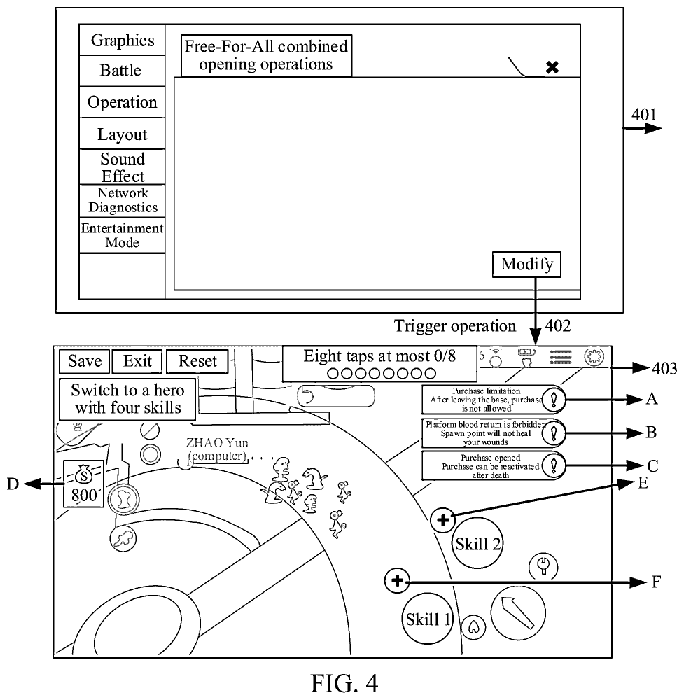

Referring to FIG. 4, it is a schematic diagram of associated settings of an opening control according to an embodiment of this disclosure. When the user taps a setting control for setting the virtual scene, the terminal, in response to a trigger operation for the setting control, presents a setting interface 401, presents an adding control 402 in the setting interface 401, and in response to a trigger operation for the adding control 402, presents an adding interface 403 of the virtual scene. The adding interface 403 is a non-real interaction interface, and compared with a real interaction interface, the adding interface 403 only retains the interaction controls for part of the functions, such as interaction controls A to F. When the user triggers the target number of interaction controls among the plurality of interaction controls, the terminal receives the selection operation for the target number of interaction controls. The target number may be set as four. When the user triggers interaction control A, interaction control B, interaction control C and interaction control D (e.g., tapping interaction control A, interaction control B, interaction control C and interaction control D), the terminal device receives a selection operation for the four interaction controls. When the user triggers a save control 404 for saving the selection operation, the terminal receives a save instruction for the selection operation, and determines operations corresponding to the target number (e.g., four) of interaction controls as the opening operations associated with the opening control.

Through the above methods, after completion of setting of the opening operations associated with the opening control, if the user triggers the opening control presented on the terminal (e.g., tapping the opening control presented in the interaction interface displayed on the terminal), then one-tap execution of the plurality of opening operations associated with the opening control may be achieved, which improves the execution efficiency of the opening operations.

In some embodiments, the terminal may receive a selection operation for a target number of interaction controls through the following methods: for the target number of interaction controls, receiving sequentially triggered touch operations (e.g., single-tap, and double-tap) for each interaction control, and determining the touch operation sequence comprised of each of the touch operations as the above-mentioned selection operation. Accordingly, the terminal device may execute the at least two opening operations associated with the opening control through the following methods: according to an operation order of each of the touch operations in the touch operation sequence, sequentially executing the opening operation associated with the interaction control corresponding to each of the touch operations.

Here, the terminal device records direct touch operations for the interaction controls, and subsequent touch operations resulting from the touch operations for the interaction controls are not within a statistical category. When the terminal device receives the touch operations for the target number of interaction controls, the operation order of each of the touch operations is recorded, and the touch operation sequence comprised of sequentially triggered touch operations is determined as the selection operation for the target number of interaction controls. For example, the user sequentially touches interaction control 1, interaction control 2, interaction control 3, interaction control 4 and interaction control 5 (for example, the user sequentially taps interaction control 1, interaction control 2, interaction control 3, interaction control 4 and interaction control 5), then a touch operation sequence comprised of touch operations for interaction control 1, interaction control 2, interaction control 3, interaction control 4 and interaction control 5 in sequence is determined as a selection operation for the five interaction controls. That is, association relationships are established between opening operations corresponding to interaction control 1, interaction control 2, interaction control 3, interaction control 4 and interaction control 5 and the opening control, respectively. When the user subsequently executes the opening operations in the interaction interface of the virtual scene through the opening control, the opening operations associated with interaction control 1, interaction control 2, interaction control 3, interaction control 4 and interaction control 5 may be sequentially executed according to the operation order of each of the touch operations in the touch operation sequence.

In some embodiments, before receiving a selection operation for a target number of interaction controls, the terminal device presents, in the adding interface, touch progress prompt information for the at least two interaction controls associated with the opening control, the touch progress prompt information being used for indicating the touch progress for the at least two interaction controls; and in a case of receiving a touch operation for a target interaction control among the target number of interaction controls, cancels display of the target interaction control, and updating the touch progress prompt information, i.e., updates the touch progress indicated by the presented touch progress prompt information.

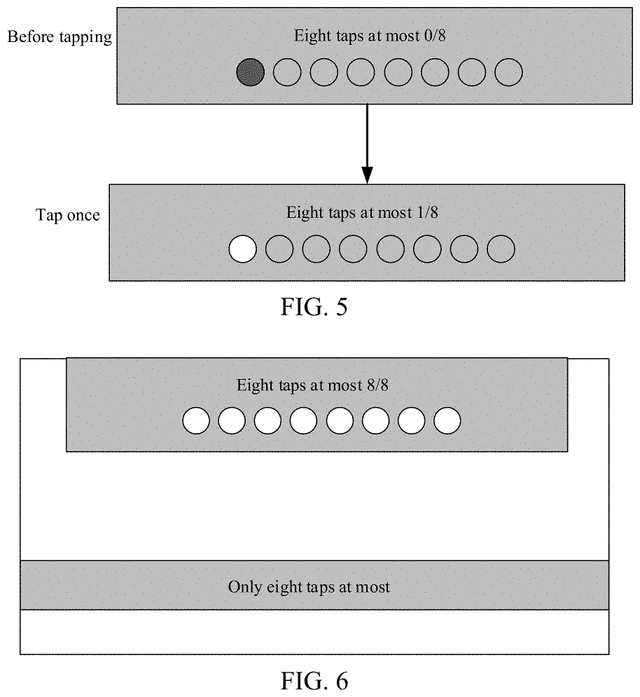

Here, in the process of setting the opening operations associated with the opening control, the terminal device updates the touch progress prompt information in real time along with the touch operations for the interaction controls. Referring to FIG. 5, it is a schematic diagram showing touch progress prompt information according to an embodiment of this disclosure. When the touch progress prompt information is represented in a style of an indicator light, the terminal device updates it in a way of “turning on a light” every time the user touches an interaction control, so as to prompt the user about the setting progress for the opening control.

In some embodiments, when a number of the acquired touch operations exceeds a number threshold, the terminal device may further present prompt information for prompting that the touch operations have reached an upper limit. Here, in practical applications, the maximum number (i.e., the number threshold) of the touch operations recorded by the terminal device may be set. That is, a number of the opening operations associated with the opening control is limited. For example, referring to FIG. 6, it is a schematic diagram showing touch upper limit prompt information according to an embodiment of this disclosure. The number of the opening operations associated with the opening control is set as eight, that is, the number threshold is eight. Then, when the number of the touch operations acquired by the terminal device reaches eight, even if the user subsequently continues touching the interaction controls, the terminal device would present prompt information for prompting that the touch operations have reached an upper limit. In this case, subsequent touch operations cannot be received. That is, the interaction operations indicated by the interaction controls subsequently touched by the user cannot be associated with the opening control.

In some embodiments, the terminal device may receive a selection operation for a target number of interaction controls through the following methods: when a first interaction control exists among the target number of interaction controls and an operation indicated by the first interaction control is a confirmation operation for interaction indication information, in response to a trigger operation for the first interaction control, receiving a selection operation for the first interaction control; and when a second interaction control exists among the target number of interaction controls and an operation indicated by the second interaction control is an equipment operation for a virtual skill, in response to a trigger operation for the second interaction control, receiving a selection operation for the second interaction control to complete the equipment operation for the corresponding virtual skill.

In practical applications, since the operation indicated by the first interaction control is the confirmation operation for the interaction indication information, when the user triggers the first interaction control corresponding to the interaction indication information, the terminal device determines the trigger operation for the first interaction control as the selection operation, and cancels display of the interaction indication information to release a display area of the terminal device occupied by the interaction indication information. There may be a plurality of first interaction controls. When the user triggers each of the first interaction controls, the terminal device will receive a selection operation for each of the first interaction controls, and after saving the selection operation, an association relationship between an interaction operation executed by each of the first interaction controls and the opening control is established. Since the operation indicated by second interaction control is the equipment operation for the virtual skill, when the user triggers the second interaction control corresponding to the virtual skill, the selection operation for the second interaction control may be received, and display for the second interaction control is canceled. Similarly, there may also be a plurality of second interaction controls. When the user triggers each of the second interaction controls, the terminal device will receive a selection operation for each of the second interaction controls, and after saving the selection operation, an association relationship between an interaction operation executed by each of the first interaction controls and the opening control may be established.

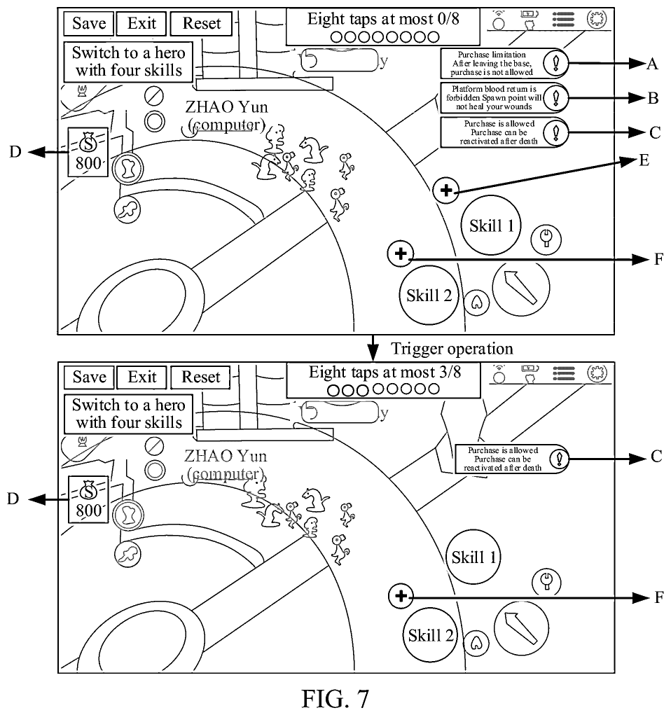

Referring to FIG. 7, it is a schematic diagram of settings of an opening control according to an embodiment of this disclosure. First interaction control A corresponding to interaction indication information 1, first interaction control B corresponding to interaction indication information 2, and second interaction control E corresponding to virtual skill 1 are presented in the adding interface. When the user triggers first interaction control A, a selection operation for first interaction control A is received, a confirmation operation is executed on interaction indication information 1, and display of interaction indication information 1 is canceled. When the user triggers first interaction control B, a selection operation for first interaction control B is received, a confirmation operation is executed on interaction indication information 2, and display of interaction indication information 2 is canceled. When the user triggers second interaction control E, a selection operation for second interaction control E is received, an equipment operation is executed on virtual skill 1, display of second interaction control E is canceled, and an icon of virtual skill 1 is highlighted. After the selection operation is saved, an association relationship between an opening operation corresponding to the interaction control triggered by the user and the opening control may be established.

In some embodiments, the terminal, in response to a trigger operation for the second interaction control, may receive a selection operation for the second interaction control through the following method: when a number of the second interaction controls is a first number, in response to a trigger operation for a second number of the second interaction controls, receiving a selection operation for the second number of the second interaction controls. Accordingly, the terminal device may control a state of a third number of the second interaction controls to change from an available state to a forbidden state. A sum of the second number and the third number is the first number.

Here, in practical applications, a number of virtual skills that can be equipped to the target virtual object may be limited. For example, a maximum number of the virtual skills that can be equipped to the target virtual object is set as two. If three second interaction controls are presented in the adding interface, and when the user triggers two of the second interaction controls, the terminal receives a selection operation for the two of the second interaction controls, and in response to the selection operation, automatically adjusts a state of the third second interaction control to a forbidden state to prohibit equipment of a virtual skill corresponding to the third second interaction control.

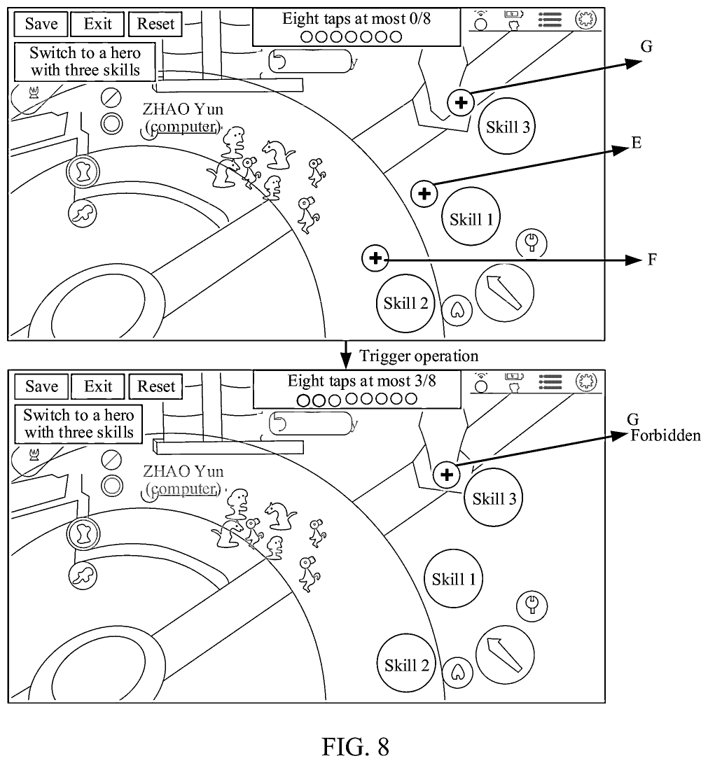

Referring to FIG. 8, it is a schematic diagram of settings of an opening control according to an embodiment of this disclosure. Second interaction control E corresponding to virtual skill 1, second interaction control F corresponding to virtual skill 2, and second interaction control G corresponding to virtual skill 3 are presented in the adding interface. Assuming that a maximum number of virtual skills that can be equipped to the target virtual object is set as two, when the user does not trigger any interaction control, second interaction control E, second interaction control F and second interaction control G are all in an available state and are highlighted. When the user triggers second interaction control E, the terminal device receives a selection operation for second interaction control E, and cancels display of second interaction control E in the adding interface. When the user triggers second interaction control F, the terminal device receives a selection operation for second interaction control F, cancels display of second interaction control F in the adding interface, and controls a state of second interaction control G to adjust from an available state to a forbidden state. For example, second interaction control G in the forbidden state is displayed in grey scale. That is, an association between an equipment operation of virtual skill 3 and the opening control cannot be established. In this way, after the selection operations are saved, association relationships between equipment operations for virtual skill 1 and virtual skill 2 and the opening control may be established.

In some embodiments, the terminal device may receive a selection operation for a target number of interaction controls through the following methods: when a third interaction control exists among the target number of interaction controls and an operation indicated by the third interaction control is a purchase operation for virtual props, in response to a trigger operation for the third interaction control, presenting a purchase interface of the virtual props, and presenting at least one candidate virtual prop in the purchase interface; in response to a selection operation for a target virtual prop among the at least one candidate virtual prop, presenting detailed information and a purchase control corresponding to the target virtual prop; and based on the detailed information, in response to a trigger operation for the purchase control, receiving a selection operation for the third interaction control to complete a purchase operation of the target virtual prop.

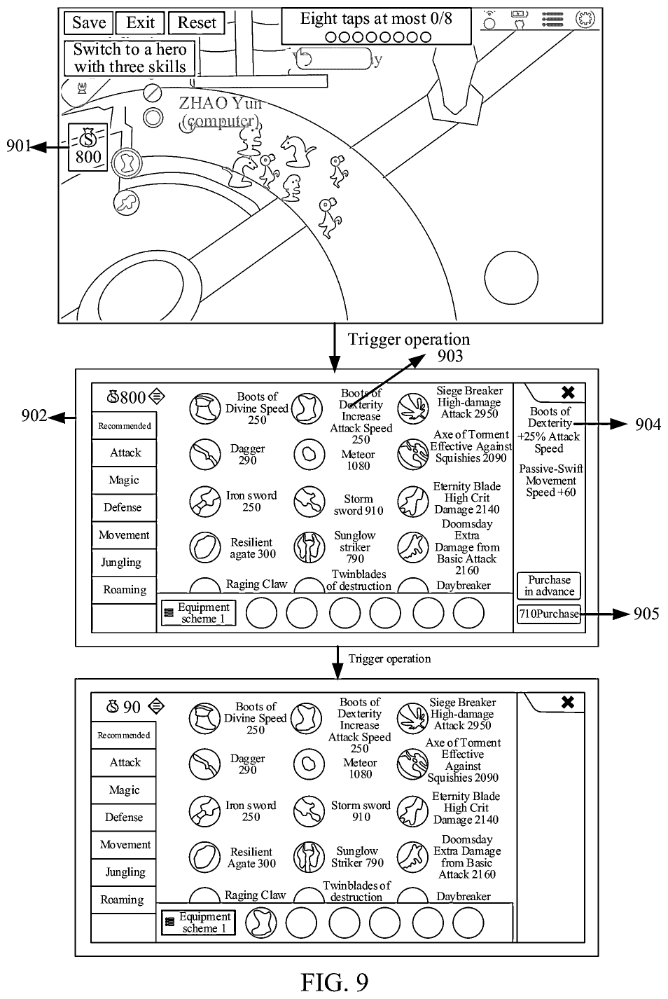

Referring to FIG. 9, it is a schematic diagram of settings of an opening control according to an embodiment of this disclosure. A third interaction control (or a purchase interaction control) 901 represented by virtual resources owned by the target virtual object is presented in the adding interface. When the user triggers the third interaction control, the terminal device, in response to the trigger operation, presents a purchase interface 902, and presents a plurality of candidate virtual props in the purchase interface as well as virtual resources required to indicate purchase of each of the candidate virtual props. In response to a trigger operation for a target virtual prop 903 among the plurality of candidate virtual props, detailed information 904 for introducing the target virtual prop 903 as well as a purchase control 905 are presented. In response to a trigger operation for the purchase control 905, when it is determined that virtual resources owned by the target virtual object is sufficient to purchase the target virtual prop, a purchase operation is executed on the target virtual prop. When the virtual resources owned by the target virtual object is not sufficient to purchase the target virtual object, indication information for prompting that the target virtual object cannot be purchased may be presented.

In some embodiments, the terminal device may present at least one candidate virtual prop in the purchase interface through the following methods: determining first virtual resources owned by the target virtual object and second virtual resources required to purchase each candidate virtual prop; based on the first virtual sources and each of the second virtual resources, screening out a first candidate virtual prop available for purchase and a second candidate virtual prop prohibited from purchase from the at least one candidate virtual prop; and presenting the first candidate virtual prop using a first style, and presenting the second candidate virtual prop using a second style different from the first style.

Here, when the terminal device displays each candidate virtual prop, it may also display first candidate virtual props corresponding to second virtual resources lower than a first virtual resource value and second candidate virtual props corresponding to second virtual resources higher than the first virtual resource value using different display styles, in combination with the first virtual resources owned by the target virtual object and the second virtual resources required to purchase each candidate virtual prop. For example, in FIG. 9, the first candidate virtual props are highlighted (tapping for purchase is allowed), and the second candidate virtual props are displayed in grey scale (tapping for purchase is not allowed). In addition, the first candidate virtual props may further arranged in front of the second candidate virtual props, such that the user quickly select virtual props that can be purchased therefrom.

In some embodiments, the terminal device may further present virtual resources owned by the target virtual object and purchased virtual prop prompt information in a process of presenting the at least one candidate virtual prop. Accordingly, after receiving a selection operation for the third interaction control, the terminal device, in response to completion of execution of a purchase operation of the target virtual prop, may further update remaining virtual resources of the target virtual object, and update the purchased virtual prop prompt information, that is, update purchased virtual prop indicated by the displayed purchased virtual prop prompt information.

Here, after it is determined that purchase for the target virtual prop is completed, the remaining virtual resources of the target virtual object may be updated in real time. As shown in FIG. 9, original virtual resources of the target virtual object are 800 yuan, and after spending 710 yuan to purchase the target virtual prop, remaining virtual resources are 90 yuan. Meanwhile, the successfully purchased target virtual prop is displayed in a purchased virtual prop list.

In some embodiments, when a target interaction control corresponding to a virtual skill exists among the at least two interaction controls, the terminal device, in the adding interface, may further present a number switching control for switching a virtual skill number; and in response to a trigger operation for the number switching control, switch a number of the target interaction controls from a fourth number to a fifth number, the fourth number being not equal to the fifth number.

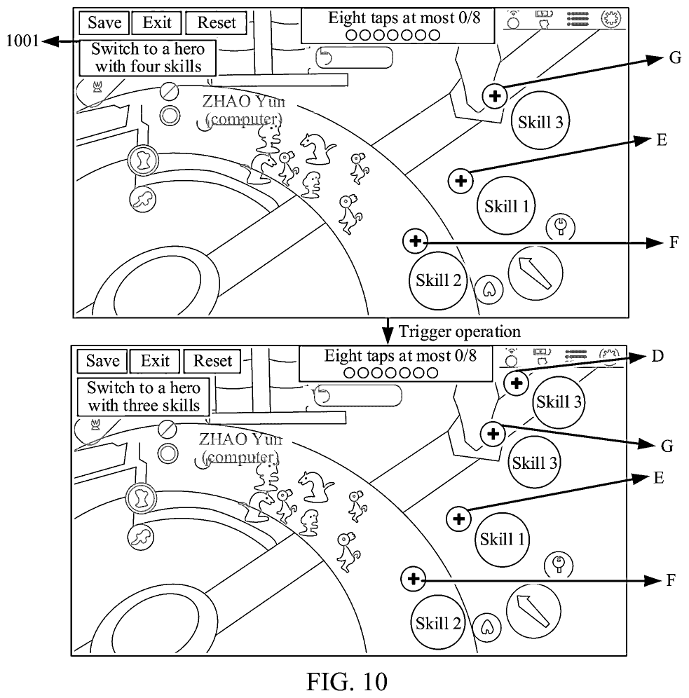

Referring to FIG. 10, it is a schematic diagram of number switching according to an embodiment of this disclosure. Three target interaction controls and a number switching control 1001 are presented in the adding interface. When the user triggers the number switching control 1001, the terminal device, in response to the trigger operation, switches a number of the target interaction controls from three to four, which enables the virtual skill number to be switched.

In some embodiments, when a target interaction control corresponding to a virtual skill exists among the at least two interaction controls, the terminal device, in the adding interface, may further present a number switching control for switching a virtual skill number. Accordingly, after receiving a selection operation for a target number of interaction controls among the at least two interaction controls, the terminal device, in response to the trigger operation for the number switching control, presents clear prompt information, the clear prompt information being used for prompting clearing of the received selection operation.

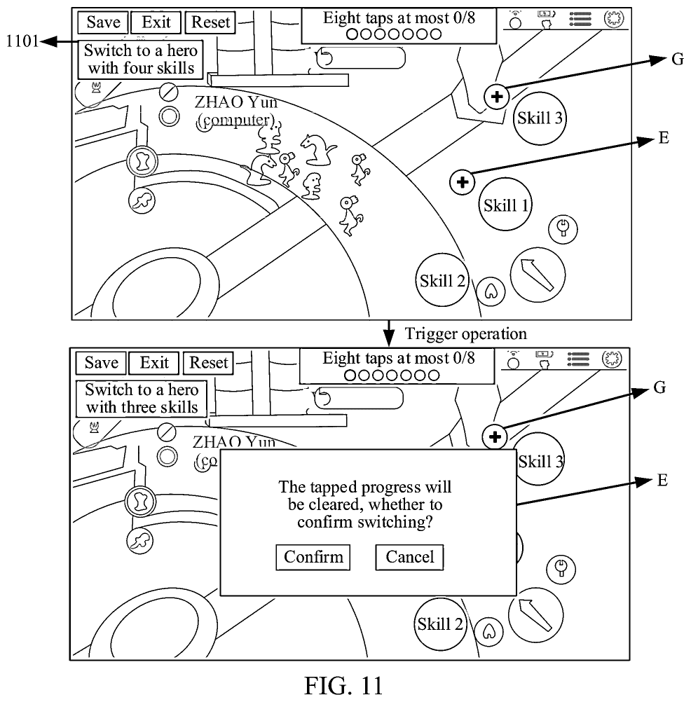

Referring to FIG. 11, it is a schematic diagram of number switching according to an embodiment of this disclosure. Three target interaction controls and a number switching control 1101 are presented in the adding interface. If the user has already triggered the target interaction controls in the adding interface before switching, then when the number switching control 1101 is triggered, the terminal device may present a double confirmation pop-up window to present prompt information, such as “the tapped progress will be cleared, whether to confirm switching”, as well as a confirm button and a cancel button. When the user taps the confirm button, the terminal device, in response to a trigger operation for the confirm button, switches the number of the target interaction controls from three to four, and clear a trigger record for the target interaction controls. When the user taps the cancel button, the terminal device, in response to a trigger operation for the cancel button, closes the pop-up window, and continues recording triggers for the three target interaction controls.

In some embodiments, after receiving a selection operation for a target number of interaction controls, the terminal device may further present a save control for saving the selection operation; in response to a trigger operation for the save control, present a confirm control for confirming the selection operation; and in response to a trigger operation for the confirmation control, receive a save instruction for the selection operation.

Here, the save control for saving settings may further be presented in the adding interface. After the terminal device receives the selection operation for the target number of interaction controls, when the user taps the save control, the terminal device, in response to a tapping operation for the save control, receives the save instruction for the selection operation for the target number of interaction controls, so as to establish association relationships between opening operations indicated by the target number of interaction controls and the opening control.

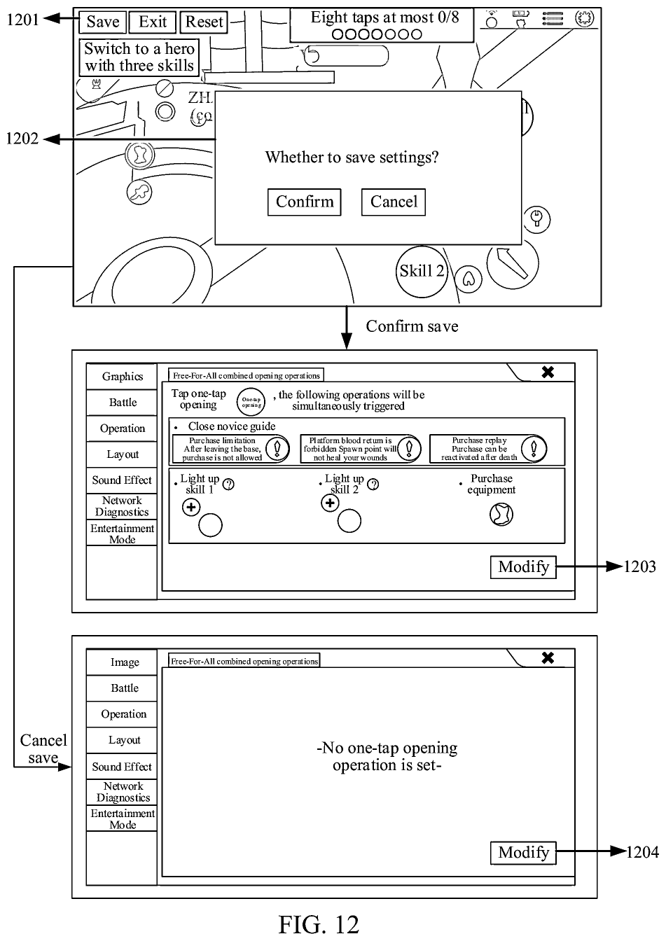

Referring to FIG. 12, it is a schematic diagram of settings of an opening control according to an embodiment of this disclosure. In practical applications, when the user taps a save control 1201 in the adding interface, the terminal device, in response to a tapping operation for the save control 1201 (i.e., a selection operation for the save control 1201), may further present a double confirmation pop-up window to present prompt information 1202, such as “whether to save settings”, as well as a confirm button and a cancel button. When the user taps the confirm button, the terminal device, in response to a trigger operation for the confirm button, receives a save instruction for a selection operation for a target number of interaction controls, saves associations between opening operations indicated by the set target number of interaction controls and the opening control, and returns to a setting interface to present the opening operations indicated by the set target number of interaction controls and present an adding control 1203. Through the adding control 1203, the opening operations associated with the opening control may be modified and adjusted. When the user taps the cancel button, the terminal device, in response to a trigger operation for the cancel button, returns to the setting interface, and displays a state before setting in the setting interface. If it is null before setting, then a null state is displayed, and an association setting of the opening control may be conducted through the adding control 1204.

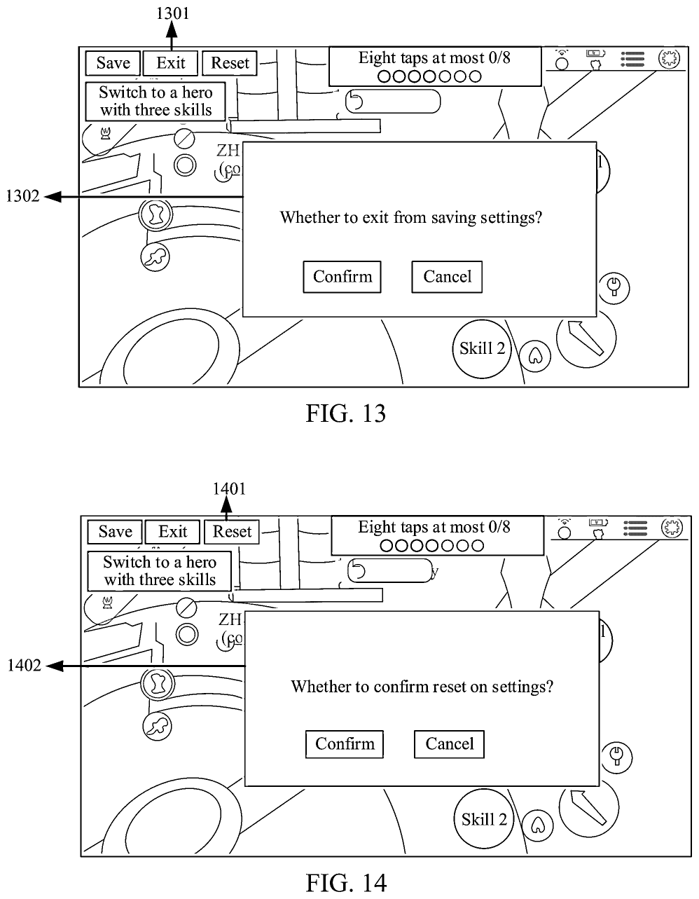

In addition, referring to FIG. 13 to FIG. 14, each of which is a schematic diagram of settings of an opening control according to an embodiment of this disclosure. In FIG. 13, an exit control 1301 for canceling the settings may further be presented in the adding interface. When the user taps the exit control 1301 in the adding interface, the terminal device, in response to a tapping operation for the exit control 1301, may further present a double confirmation pop-up window to present prompt information 1302, such as “whether to exit from saving settings”, as well as a confirm button and a cancel button. When the user taps the confirm button, the terminal device, in response to a trigger operation for the confirm button, receives a save cancel instruction for a selection operation for a target number of interaction controls, returns to a setting interface, and displays a state before setting in the setting interface. In FIG. 14, a reset control 1401 for resetting the settings may further be presented in the adding interface. When the user taps the reset control 1401 in the adding interface, the terminal device, in response to a tapping operation for the reset control 1401, may further present a double confirmation pop-up window to present prompt information 1402, such as “whether to confirm reset on settings”, as well as a confirm button and a cancel button. When the user taps the confirm button, the terminal device, in response to a trigger operation for the confirm button, receives a save cancel instruction for a selection operation for a target number of interaction controls, returns to a setting interface, and displays a state before setting in the setting interface, that is, restores to an original state.

At step 102, in response to a trigger operation for the opening control, at least two opening operations are executed.

When the user triggers (e.g., taps, double-taps, and slides) the opening control, the terminal may execute the plurality of opening operations associated with the opening control. For example, if the opening operations associated with the opening control are opening operation 1, opening operation 2, opening operation 3 and opening operation 4, then the terminal, in response to a trigger operation for the opening control, executes opening operation 1, opening operation 2, opening operation 3 and opening operation 4 to complete an interaction preparation operation corresponding to each of the opening operations. The interaction preparation operations corresponding to the different opening operations may be the same or different.

In some embodiments, before the terminal device executes the at least two opening operations associated with the opening control, when the interaction preparation operations are confirmation operations for interaction indication information, the interaction indication information may further be presented in the interaction interface of the virtual scene. Accordingly, after the terminal executes the at least two opening operations to execute the corresponding interaction preparation operations, in response to completion of execution of the interaction preparation operations, presentation of the interaction indication information is canceled to release a display area of the terminal occupied by the interaction indication information, which improves the utilization of graphics display resources of the terminal.

Here, for the interaction indication information (e.g., novice indication information) presented in the interaction interface of the virtual scene, if the user does not execute opening operations (i.e., confirmation operations, and interaction preparation operations) on the interaction indication information, then the interaction indication information would always be presented in the interaction interface, which may affect the user's control of an interaction of the target virtual object in the virtual scene. If the user executes the opening operations (i.e., confirmation operations, and interaction preparation operations) on the interaction indication information, then the interaction indication information would release the area it occupies in the interaction interface. There may be one or more (two or more) pieces of interaction indication information. When a plurality of pieces of interaction indication information are presented in the interaction interface and are all associated into the opening control, the terminal, in response to a trigger operation for the opening control, cancels presentation of the plurality of pieces of interaction indication information to release the areas the plurality of pieces of interaction indication information occupy respectively in the interaction interface. In practical applications, the presentation forms of the interaction indication information presented by the terminal may include at least one of the following: a text form, an animation form and a picture form.

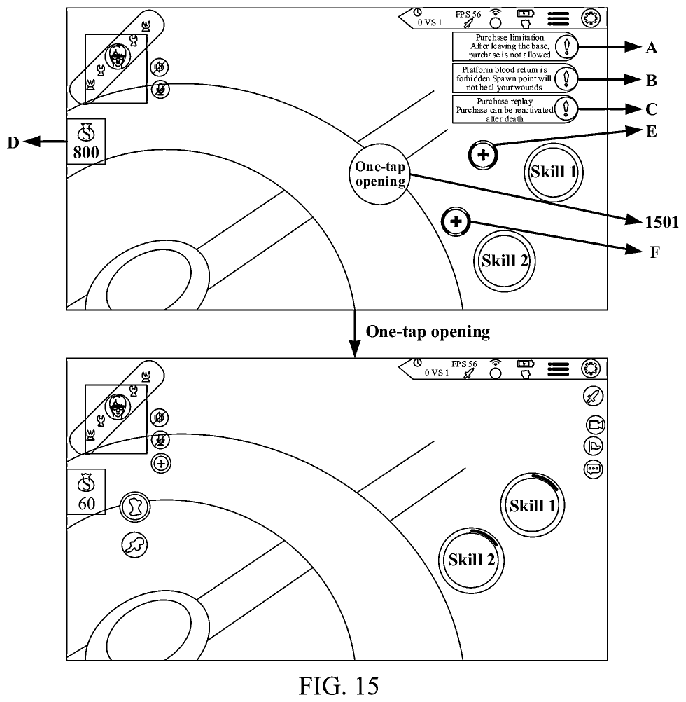

Referring to FIG. 15, it is a schematic diagram presenting opening operations according to an embodiment of this disclosure. Interaction indication information A, interaction indication information B and interaction indication information C are presented in the interaction interface of the virtual scene, and the three pieces of interaction indication information are all associated with the opening control 1501. When the user triggers the opening control 1501, the terminal device, in response to the trigger operation, executes confirmation operations for interaction indication information A, interaction indication information B and interaction indication information C. After completion of confirmation, display of interaction indication information A, interaction indication information B and interaction indication information C is canceled. The confirmation operations for the three pieces of interaction indication information may be executed simultaneously and in parallel, and may also be executed in series according to a set preset order. As such, by triggering the opening control once, the plurality of opening operations associated therewith may be executed through one tap, which may improve execution efficiency of the opening operations, thus achieving a favorable opening effect, and enabling the player to quickly enter the battle.

In some embodiments, the terminal, in response to a trigger operation for the opening control, may execute the at least two opening operations to execute the corresponding interaction preparation operations through the following methods: when the interaction preparation operations are equipment operations for virtual skills, in response to the trigger operation for the opening control, executing an equipment operation for a corresponding virtual skill; and accordingly, in response to completion of execution of the equipment operation for the virtual skill, controlling an operating control corresponding to the virtual skill to be in an activated state.

Here, when an association setting of the opening control is conducted, the virtual skills of the target virtual object may be associated with the opening control, such that when the terminal device receives the trigger operation for the opening control, the equipment operations or activation operations are executed on the associated virtual skills. There may be one or more (two or more) associated virtual skills. The equipment operations of the associated virtual skills may be executed simultaneously and in parallel, and may also be executed in series according to a set preset order.

Still referring to FIG. 15, virtual skill 1 (corresponding to interaction control E) and virtual skill 2 (corresponding to interaction control F) to be activated are presented in the interaction interface of the virtual scene, and the two virtual skills are both associated with the opening control 1501. When the user triggers the opening control 1501, the terminal device, in response to the trigger operation, executes equipment operations (or activation operations) for virtual skill 1 and virtual skill 2. After completion of execution of the equipment operations or the activation operations, the equipped or activated virtual skills are controlled to be in an activated state, and display of an interaction control for independently equipping or activating a certain virtual skill is canceled, and the interaction controls of the equipped or activated virtual skills are displayed using a target display style. For example, before equipping, icons corresponding to the virtual skills are displayed in grey scale, after equipping, the icons of the virtual skills are highlighted, and display of corresponding interaction controls E and F is canceled. As such, by triggering the opening control once, the plurality of opening operations associated therewith may be executed through one tap, which greatly shortens an operation path of opening in the virtual scene, reduces the number of operations required to complete a plurality of opening operations required for opening, and improves execution efficiency of the opening operations and human-computer interaction efficiency, thus achieving a favorable opening effect, and enabling the player to quickly enter the battle.

In some embodiments, the terminal, in response to a trigger operation for the opening control, may execute the at least two opening operations to execute the corresponding interaction preparation operations through the following methods: when the interaction preparation operations are purchase operations for virtual props, in response to the trigger operation for the opening control, executing a purchase operation of a corresponding virtual prop; and accordingly, in response to completion of execution of the purchase operation, presenting the virtual prop indicated for purchase by the purchase operation in the interaction interface.

Here, when an association setting of the opening control is conducted, the virtual props required to be purchased by the target virtual object may be associated with the opening control, such that when the terminal device receives the trigger operation for the opening control, the purchase operations are executed on the associated virtual props. There may be one or more (two or more) associated virtual props. The purchase operations of the associated virtual props may be executed simultaneously and in parallel, and may also be executed in series according to a set preset order.

Still referring to FIG. 15, in the interaction interface of the virtual scene, purchase interaction control D for independently executing the purchase operations of the virtual props is presented. The purchase interaction control may be represented by the virtual resources owned by the target virtual object. When an association setting of the opening control 1501 is conducted, the purchase operations of the virtual props are associated with the opening control. The terminal, in response to a trigger operation for the opening operations, may execute the purchase operations on the associated virtual props through one tap regardless of one or more associated virtual props, and the purchased virtual props are presented in the interaction interface. As such, by triggering the opening control once, the plurality of opening operations associated therewith may be executed through one tap, which improves execution efficiency of the opening operations, thus achieving a favorable opening effect, and enabling the player to quickly enter the battle.

In practical applications, the opening control may further be associated with a plurality of different interaction preparation operations (i.e., opening operations). As shown in FIG. 15, the opening control is associated with the opening operations for confirming interaction indication information A, interaction indication information B and interaction indication information C (i.e., interaction preparation operations), the opening operations for equipping virtual skill 1 and virtual skill 2, and the opening operation for purchasing virtual prop A. In this case, when the user triggers the opening control, the terminal, in response to a trigger operation for the opening control, one-tap execution of all the opening operations associated with the opening control may be conducted to complete all the interaction preparation operations, which improves execution efficiency of the opening operations.

At step 103, in response to completion of execution of the interaction preparation operations, presentation of the opening control is canceled, and a battle interface is presented, the battle interface being used for the target virtual object to interact with the other virtual objects in a battle.

Here, in a case of completion of execution of the plurality of opening operations associated with the opening control (i.e., all the interaction preparation operations), the interaction battle in the virtual scene is opened. The terminal cancels presentation of the opening control and presents the battle interface of the opened interaction battle, so as to enable the user to control the target virtual object to interact with the other virtual objects in the battle based on the battle interface. By triggering the execution of the plurality of opening operations with one tap, the target virtual object interacts with other virtual objects in the virtual scene in the optimal case (for example, the target virtual object is equipped with virtual skills and virtual props, and no interaction indication information is blocked in the interaction interface).

For example, in FIG. 15, the opening control 1501 is associated with the opening operations corresponding to interaction indication information A to C, purchase interaction control D, virtual skill 1 (corresponding to interaction control E), and virtual skill 2 (corresponding to interaction control E). When the user triggers the opening control 1501, interaction indication information A to C may be confirmed. After completion of confirmation, display of interaction indication information A to C is canceled. The purchase operations are executed on the virtual props, and the purchased virtual props are presented in the interaction interface. The equipment operations are executed on virtual skill 1 and virtual skill 2. After completion of execution of the equipment operations, display of corresponding interaction controls E and F is canceled, and the battle interface of the opened interaction battle is displayed, so as to enable the user to control the target virtual object to interact with the other virtual objects in the battle based on the battle interface. As such, by triggering the opening control once, the plurality of opening operations associated therewith may be executed through one tap. Compared with the related technology in which interaction controls for each of the opening operation are tapped one by one to execute the corresponding opening operation, an operation path of opening in the virtual scene is greatly shortened, the number of operations required to complete the plurality of opening operations required for opening is reduced, one-tap opening for the virtual scene is achieved, and execution efficiency of the opening operations and human-computer interaction efficiency are improved, thus achieving a favorable opening effect, and enabling the player to quickly enter the battle.

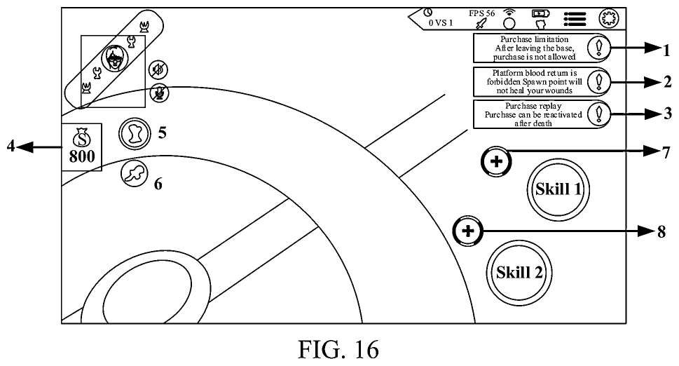

Hereinafter, a description is made of an exemplary application of the embodiment of this disclosure in an practical application scene. Taking a virtual scene for a game as an example, each opening requires the player to execute a series of identical opening operations. Referring to FIG. 16, it is a schematic diagram displaying opening operations according to an embodiment of this disclosure. FIG. 16 shows that this time, eight taps are needed to complete the opening operations. Numbers are a tapping execution order of the opening operations, where one is to tap novice prompt information 1, two is to tap novice prompt information 2, three is to tap novice prompt information 3, four is to tap to open a virtual prop purchase interface, five is to select a virtual prop that needs to be purchased, six is to tap purchase, seven is to activate virtual skill 1, and eight is to activate virtual skill 2. If the player mistakenly operates or misses an operation, then unfavorable opening would be caused. In order to achieve a favorable opening effect, the player needs to execute the opening operations one by one multiple times, resulting in low opening efficiency.

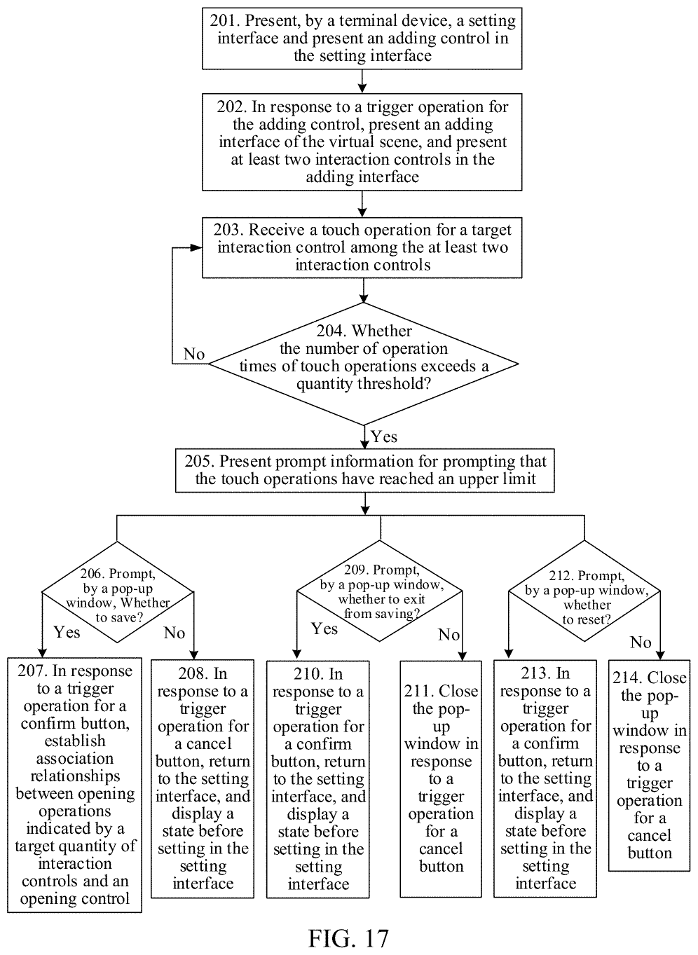

For this purpose, provided in an embodiment of this disclosure is a method for controlling opening operations in a virtual scene. The opening efficiency may be improved through an opening control associated with a plurality of opening operations. In practical applications, before presenting the opening control in an interaction interface of a virtual scene, the plurality of opening operations associated with the opening control need to be set firstly. Referring to FIG. 17, it is a schematic flow diagram of a method for setting an opening control in a virtual scene according to an embodiment of this disclosure. The method includes:

At step 201, a terminal device presents a setting interface, and presents an adding control in the setting interface.

As shown in FIG. 4, the setting interface 401 is used for setting the opening operations associated with the opening control, and the adding control 402 is used for adding the opening operations associated with the opening control.

At step 202, in response to a trigger operation for the adding control, an adding interface of the virtual scene is presented, and at least two interaction controls are presented in the adding interface.

The adding interface is a non-real interaction interface, and compared with a real interaction interface, the adding interface only retains the interaction controls for part of the functions, such as interaction controls A to F shown in FIG. 4.

At step 203, a touch operation for a target interaction control among the at least two interaction controls is received.

In practical applications, only a touch operation (e.g., a tapping operation) for an effective interaction control may be recoded as one tap, while a touch operation for an unresponsive area such as a blank area or a forbidden interaction control may not be recorded.

Here, in the process of setting the opening operations associated with the opening control, the terminal device updates touch progress prompt information in real time along with touch operations for the interaction controls. For example, the touch progress prompt information is represented in a style of an indicator light, the terminal device updates it in a way of “turning on a light” every time the user touches an interaction control, so as to prompt the user about the setting progress for the opening control. Moreover, when the terminal device receives the touch operation for the target interaction control, the target interaction control in the adding interface will present a feedback basically consistent with the interaction interface (i.e., in a battle).

For example, when an operation indicated by the target interaction control is a confirmation operation for novice prompt information, the terminal device, in response to the touch operation for the target interaction control, cancels display of the target interaction control and the novice prompt information to release an occupied area. For another example, when an operation indicated by the target interaction control is an equipment operation for a virtual skill, the terminal device, in response to a touch operation for the target interaction control, cancels display of the target interaction control, and highlights an icon of the corresponding virtual skill (which represents that the virtual skill is in an activated available state). For another example, when an operation indicated by the target interaction control is a purchase operation for virtual props, the terminal device, in response to a touch operation for the target interaction control, presents a purchase interface of the virtual props, and presents at least one candidate virtual prop in the purchase interface; in response to a selection operation for a target virtual prop among the at least one candidate virtual prop, presenting detailed information and a purchase control corresponding to the target virtual prop; and based on the detailed information, in response to a trigger operation for the purchase control, completes a purchase operation of the target virtual prop.

At step 204, whether the number of operations of touch operations exceeds a number threshold is judged.

Here, in practical applications, the maximum number (i.e., the number threshold) of the touch operations recorded by the terminal device may be set. That is, a number of the opening operations associated with the opening control is limited. For example, the number of the opening operations associated with the opening control is set as eight, that is, the number threshold is eight. Then, when the number of the touch operations acquired by the terminal device reaches eight, step 205 is performed. Otherwise, step 203 is performed.

At step 205, prompt information for prompting that the touch operations have reached an upper limit is presented.

Here, when the number of operation times of the touch operations exceeds the number threshold, even if the user subsequently continues touching the interaction controls, the terminal device cannot receive subsequent touch operations. That is, the interaction operations indicated by the interaction controls subsequently touched by the user cannot be associated with the opening control.

At step 206, in response to a trigger operation for a save control, whether the touch operations are saved is judged.

Here, the save control is presented in the adding interface. When the user triggers the save control, the terminal device, in response to a trigger operation for the save control, presents a double confirmation pop-up window to present prompt information, such as “whether to save the scheme”, as well as a confirm button and a cancel button corresponding to the prompt information. When the user taps the confirm button to save the trigger operation, step 207 is performed. When the user taps the cancel button, the trigger operation is not saved, and step 208 is performed.

At step 207, the terminal device, in response to the trigger operation for the confirm button, establishes association relationships between the opening operations indicated by the target number of interaction controls and the opening control.

Here, the terminal device receives a save instruction for the touch operations for the target number of interaction controls, so as to establish the association relationships between opening operations indicated by the target number of interaction controls and the opening control. For example, the user sequentially touches an interaction control corresponding to novice prompt information 1, an interaction control corresponding to novice prompt information 2, an interaction control corresponding to novice prompt information 3, an interaction control for purchasing virtual props, an interaction control for activating virtual skill 1, and an interaction control for activating virtual skill 2. Then, after confirming to save touch operations for the above interaction controls, an association relationship between the opening control and an opening operation corresponding to each of the interaction controls may be established, and the opening operations indicated by the set target number of interaction controls may be presented in the setting interface.

After setting the association between the opening control and each of the opening operations, when the user triggers the opening control in the interaction interface (i.e., in a battle), one-tap execution of all the opening operations associated with the opening control may be conducted. That is, after confirming novice prompt information 1, novice prompt information 2 and novice prompt information 3, display of each piece of novice prompt information is canceled to release an occupied area, the virtual props are purchased, virtual skill 1 and virtual skill 2 are equipped, and the purchased virtual props and the icons of the equipped virtual skills are highlighted (which represents that they are in an activated available state).

At step 208, the terminal device, in response to a trigger operation for the cancel button, returns to the setting interface, and displays a state before setting in the setting interface.

At step 209, the terminal device, in response to a trigger operation for an exit button, judges whether to exit from saving the touch operations.

Here, the exit control for canceling settings may further be presented in the adding interface. When the user triggers the exit control, the terminal device, in response to a trigger operation for the exit control, presents a double confirmation pop-up window to present prompt information, such as “whether to confirm unsaying the scheme”, as well as a confirm button and a cancel button. When the user taps the confirm button to exit from saving the touch operations, step 210 is performed. When the user taps the cancel button, step 211 is performed.

At step 210, the terminal device, in response to a trigger operation for the confirm button, returns to the setting interface, and displays a state before setting in the setting interface.

At step 211, the terminal device, in response to a trigger operation for the cancel button, closes the pop-up window.

At step 212, the terminal device, in response to a trigger operation for a reset button, judges whether to reset the touch operations.

Here, a reset control for resetting the settings may further be presented in the adding interface. When the user triggers the reset control, the terminal device, in response to a trigger operation for the reset control, presents a double confirmation pop-up window to present prompt information, such as “whether to confirm resetting the scheme”, as well as a confirm button and a cancel button. When the user taps the confirm button, step 213 is performed. When the user taps the cancel button, step 214 is performed.

At step 213, the terminal device, in response to a trigger operation for the confirm button, returns to the setting interface, and displays a state before setting in the setting interface.

Here, after resetting, the touch operations for the interaction controls will be clear to zero, and all the interaction controls are restored to an initial untouched state.

At step 214, the terminal device, in response to a trigger operation for the cancel button, closes the pop-up window.

Through the above methods, provided in the embodiment of this disclosure is an opening control capable of being associated with a plurality of opening operations in a customized mode. All the opening operations associated with the opening control may be executed through a single trigger operation for the opening operations. Compared with tapping an interaction control for each of opening operations one by one to execute the corresponding opening operation, an operation path or the number of operations of opening operations executed for completing all interaction preparation operations is greatly shortened, and opening efficiency is improved. Meanwhile, the possibility of missing certain opening operations is greatly reduced, the deadweight loss of the player in gameplay is avoided, and user experience is improved.

The following continues to describe an exemplary structure of the apparatus 465 for controlling opening operations in a virtual scene according to the embodiment of this disclosure implemented as a software module. In some embodiments, the software module in the apparatus 465 for controlling opening operations in a virtual scene stored in the memory 460 in FIG. 2 may include:
a control presentation module 4651, configured to present a target virtual object and an opening control of a virtual scene; the opening control being associated with at least two opening operations, and the opening operations being interaction preparation operations before the target virtual object interacts with other virtual objects; an operation execution module 4652, configured to, in response to a trigger operation for the opening control, execute the at least two opening operations; and a control cancel module 4653, configured to, in response to completion of execution of the at least two opening operations, cancel presentation of the opening control and present a battle interface, the battle interface being used for the target virtual object to interact with the other virtual objects in a battle.

In some embodiments, the apparatus further includes: an information presentation module, configured to, before executing the at least two opening operations, when the interaction preparation operations are confirmation operations for the interaction indication information, present the interaction indication information in an interface of the virtual scene.

The apparatus further includes: an information cancellation module, configured to, after execution of the at least two opening operations, in response to completion of execution of the interaction preparation operations, cancel presentation of the interaction indication information to release an area occupied by the interaction indication information.

In some embodiments, the operation execution module is further configured to, when the interaction preparation operations are equipment operations for virtual skills, in response to the trigger operation for the opening control, execute an equipment operation for a corresponding virtual skill. The apparatus further includes: an activation control module, configured to, in response to completion of execution of the equipment operation for the virtual skill, control an operating control corresponding to the virtual skill to be in an activated state.

In some embodiments, the operation execution module is further configured to, when the interaction preparation operations are purchase operations for virtual props, in response to the trigger operation for the opening control, execute a purchase operation for a corresponding virtual prop. The apparatus further includes: a prop purchase module, configured to, in response to completion of execution of the purchase operation, present in the interaction interface the virtual prop indicated for purchase by the purchase operation.

In some embodiments, the apparatus further includes: a control association module, configured to, before presenting the opening control, present a setting interface for setting the opening operations associated with the opening control, and present, in the setting interface, an adding control for adding the opening operations; in response to a trigger operation for the adding control, present an adding interface of the virtual scene, and present at least two interaction controls in the adding interface, a number of the interaction controls being greater than or equal to a target number; receive a selection operation for the target number of interaction controls; and in response to a save instruction for the selection operation, determine operations corresponding to the target number of interaction controls as the at least two opening operations associated with the opening control.

In some embodiments, the selection operation includes a touch operation sequence for the target number of interaction controls. The control association module is further configured to, for the target number of interaction controls, receive sequentially triggered touch operations for each interaction control, and determine the touch operation sequence comprised of each of the touch operations as the selection operation. The operation execution module is further configured to, according to an operation order of each of the touch operations in the touch operation sequence, execute the opening operation associated with the interaction control corresponding to each of the touch operations.

In some embodiments, the apparatus further includes: a progress prompt module, configured to, before receiving a selection operation for the target number of interaction controls, present, in the adding interface, touch progress prompt information for the at least two interaction controls, the touch progress prompt information being used for indicating the touch progress for the at least two interaction controls. The apparatus further includes: a progress updating module, configured to, in a case of receiving a touch operation for a target interaction control among the target number of interaction controls, cancel display of the target interaction control, and update the touch progress prompt information.

In some embodiments, the apparatus further includes: an upper limit prompt module, configured to, when a number of the received touch operations exceeds a number threshold, present prompt information for prompting that the touch operations have reached an upper limit.

In some embodiments, the control association module is further configured to, when a first interaction control exists among the target number of interaction controls and an operation indicated by the first interaction control is a confirmation operation for the interaction indication information, in response to a trigger operation for the first interaction control, receive a selection operation for the first interaction control; and when a second interaction control exists among the target number of interaction controls and an operation indicated by the second interaction control is the equipment operation for the virtual skill, in response to a trigger operation for the second interaction control, receive a selection operation for the second interaction control to complete the equipment operation for the corresponding virtual skill.

In some embodiments, the control association module is further configured to, when a number of the second interaction controls is a first number, in response to a trigger operation for the second number of the second interaction controls, receive a selection operation for a second number of the second interaction controls. The apparatus further includes: a state change module, configured to control a state of a third number of the second interaction controls to change from an available state to a forbidden state; a sum of the second number and the third number being the first number.

In some embodiments, the control association module is further configured to, when the third interaction control exists among the target number of interaction controls and an operation indicated by the third interaction control is a purchase operation for virtual props, in response to a trigger operation for the third interaction control, present a purchase interface of the virtual props, and present at least one candidate virtual prop in the purchase interface; in response to a selection operation for a target virtual prop among the at least one candidate virtual prop, present detailed information and a purchase control corresponding to the target virtual prop; and based on the detailed information, in response to a trigger operation for the purchase control, receive a selection operation for the third interaction control to complete a purchase operation of the target virtual prop.

In some embodiments, the control association module is further configured to determine first virtual resources owned by the target virtual object and second virtual resources required to purchase each candidate virtual prop; based on the first virtual sources and each of the second virtual resources, screen out a first candidate virtual prop available for purchase and a second candidate virtual prop prohibited from purchase from the at least one candidate virtual prop; and present the first candidate virtual prop using a first style, and present the second candidate virtual prop using a second style different from the first style.

In some embodiments, the apparatus further includes: a prop purchase prompt module, configured to, in a process of presenting the at least one candidate virtual prop in the purchase interface, present virtual resources owned by the target virtual object and purchased virtual prop prompt information. The apparatus further includes: a prop purchase updating module, configured to, after receiving a selection operation for the third interaction control, in response to completion of execution of a purchase operation of the target virtual prop, update presentation of remaining virtual resources of the target virtual object, and update display of the purchased virtual prop prompt information.

In some embodiments, the apparatus further includes: a skill switching module, configured to, when a target interaction control corresponding to a virtual skill exists among the at least two interaction controls, present, in the adding interface, a number switching control for switching a virtual skill number; and in response to a trigger operation for the number switching control, switch a number of the target interaction control from a fourth number to a fifth number, the fourth number being not equal to the fifth number.

In some embodiments, the apparatus further includes: a switching presentation module, configured to, when a target interaction control corresponding to a virtual skill exists among the at least two interaction controls, present, in the adding interface, a number switching control for switching a virtual skill number. The apparatus further includes: a clear prompt module, configured to, after receiving a selection operation for a target number of interaction controls among the at least two interaction controls, in response to a trigger operation for the number switching control, present clear prompt information for prompting clearing of the received selection operation.

In some embodiments, the apparatus further includes: a save receiving module, configured to, after receiving a selection operation for a target number of interaction controls, present a save control for saving the selection operation; in response to a trigger operation for the save control, present a confirmation control for confirming the selection operation; and in response to a trigger operation for the confirmation control, receive a save instruction for the selection operation.

Provided in an embodiment of this disclosure is a computer program product or a computer program. The computer program product or the computer program includes a computer instruction, which is stored in a computer-readable storage medium. A processor of a computer device reads the computer instruction from the computer-readable storage medium. The processor executes the computer instruction, such that the computer device performs the method for controlling opening operations in a virtual scene according to the embodiment of this disclosure.

Provided in an embodiment of this disclosure is a computer-readable storage medium storing an executable instruction. The executable instruction, when executed by a processor, will cause the processor to perform the method for controlling opening operations in a virtual scene according to the embodiment of this disclosure, e.g., the method as shown in FIG. 3.

In some embodiments, the computer-readable storage medium may be a read-only memory (ROM), a random access memory (RAM), an erasable programmable read-only memory (EPROM), an electrically erasable programmable read-only memory (EEPROM), a flash memory, a magnetic surface memory, an optical disk, or CD-ROM, etc. It may also be a variety of devices including one of the above-mentioned memories or any combination thereof.

In some embodiments, the executable instruction may be written in any form of programming language (including a compiled or interpreted language, or a declarative or procedural language) using the form of a program, software, a software module, a script or a code, and may be deployed in any form, including as an stand-alone program or as a module, a component, a subroutine, or other units suitable for use in a computing environment.

As an example, the executable instruction may, but do not necessarily, correspond to a file in a file system. It may be stored as part of a file that holds other programs or data. For example, it may be stored in one or more scripts in a hyper text markup language (HTML) document, stored in a single file dedicated to a program under discussion, or stored in multiple co-files (e.g., files that store one or more modules, subprograms, or code sections).

As an example, the executable instruction may be deployed to execute on one computing device, or on multiple computing devices located in one place, or on multiple computing devices distributed in multiple places and interconnected via a communication network.

The foregoing descriptions are merely embodiments of this disclosure, but are not intended to limit the protection scope of this disclosure. Any modifications, equivalent replacements, improvements and the like made within the spirit and scope of this disclosure shall fall within the protection scope of this disclosure.

What is claimed is:

1. A method for controlling opening operations in a virtual scene, comprising:
presenting a target virtual object and an opening control of the virtual scene, the opening control being associated with at least two opening operations, and the opening operations being interaction preparation operations before the target virtual object interacts with another virtual object;
in response to a trigger operation for the opening control, executing the at least two opening operations; and
in response to completion of execution of the at least two opening operations, canceling presentation of the opening control, and presenting a battle interface, the battle interface being for the target virtual object to interact with the another virtual object in a battle.

2. The method according to claim 1, wherein the interaction preparation operations are confirmation operations for interaction indication information, the method further comprises:
presenting the interaction indication information; and
in response to completion of execution of the at least two opening operations, canceling presentation of the interaction indication information.

3. The method according to claim 1, wherein the interaction preparation operations are equipment operations for virtual skills, and the executing the at least two opening operations comprises:
in response to the trigger operation for the opening control, executing an equipment operation for a corresponding virtual skill; and
the method further comprises:
in response to completion of execution of the equipment operation for the virtual skill, controlling an operating control corresponding to the virtual skill to be in an activated state.

4. The method according to claim 1, wherein the interaction preparation operations are purchase operations for virtual props, and the executing the at least two opening operations comprises:
in response to the trigger operation for the opening control, executing a purchase operation of a corresponding virtual prop; and
the method further comprises:
in response to completion of execution of the purchase operation, presenting the virtual prop indicated for purchase by the purchase operation.

5. The method according to claim 1, wherein the method further comprises:
presenting a setting interface, the setting interface being for setting the opening operations associated with the opening control;
presenting, in the setting interface, an adding control for adding the opening operations;
in response to a trigger operation for the adding control, presenting an adding interface of the virtual scene, and presenting at least two interaction controls in the adding interface;
receiving a selection operation for a target number of interaction controls; and
in response to a save instruction for the selection operation, determining operations corresponding to the target number of interaction controls as the at least two opening operations associated with the opening control.

6. The method according to claim 5, wherein the receiving the selection operation for the target number of interaction controls comprises:
receiving sequentially triggered touch operations for each of the target number of interaction controls, and determining a touch operation sequence of the touch operations as the selection operation; and
the executing the at least two opening operations comprises:
according to an operation order of each of the touch operations in the touch operation sequence, executing the opening operations associated with the interaction controls corresponding to each of the touch operations.

7. The method according to claim 6, wherein the method further comprises:
presenting, in the adding interface, touch progress prompt information for the at least two interaction controls; and
the method further comprises:
in response to receiving a touch operation for a target interaction control among the target number of interaction controls, canceling presentation of the target interaction control, and updating the touch progress prompt information.

8. The method according to claim 6, wherein the method further comprises:
in response to a number of the received touch operations exceeding a number threshold, presenting prompt information that the touch operations have reached an upper limit.

9. The method according to claim 5, wherein a first interaction control exists among the target number of interaction controls and an operation indicated by the first interaction control is a confirmation operation for interaction indication information, and the receiving the selection operation for the target number of interaction controls comprises:
in response to a trigger operation for the first interaction control, receiving a selection operation for the first interaction control.

10. The method according to claim 9, wherein a second interaction control exists among the target number of interaction controls and an operation indicated by the second interaction control is an equipment operation for a virtual skill, the receiving the selection operation for the target number of interaction controls comprises:
in response to a trigger operation for the second interaction control, receiving a selection operation for the second interaction control.

11. The method according to claim 10, wherein a number of the second interaction controls is a first number, and the receiving the selection operation for the second interaction control comprises:
in response to a trigger operation for a second number of the second interaction controls, receiving a selection operation for the second number of the second interaction controls.

12. The method according to claim 11, wherein the method further comprises:
controlling a state of a third number of the second interaction controls to change from an available state to a forbidden state, a sum of the second number and the third number being the first number.

13. The method according to claim 5, wherein a third interaction control exists among the target number of interaction controls and an operation indicated by the third interaction control is a purchase operation for virtual props, and the receiving the selection operation for the target number of interaction controls comprises:
in response to a trigger operation for the third interaction control, presenting a purchase interface of the virtual props, and presenting at least one candidate virtual prop in the purchase interface;
in response to a selection operation for a target virtual prop among the at least one candidate virtual prop, presenting detailed information and a purchase control corresponding to the target virtual prop; and
in response to a trigger operation for the purchase control, receiving a selection operation for the third interaction control based on the detailed information.

14. The method according to claim 13, wherein the presenting the at least one candidate virtual prop in the purchase interface comprises:
determining first virtual resources owned by the target virtual object and second virtual resources required to purchase each candidate virtual prop;
based on the first virtual sources and each of the second virtual resources, screening out a first candidate virtual prop available for purchase and a second candidate virtual prop prohibited from purchase from the at least one candidate virtual prop; and
presenting the first candidate virtual prop with a first style, and presenting the second candidate virtual prop with a second style different from the first style.

15. The method according to claim 13, wherein the method further comprises:
presenting virtual resources owned by the target virtual object and purchased virtual prop prompt information; and
in response to completion of execution of a purchase operation of the target virtual prop, updating remaining virtual resources of the target virtual object, and updating the purchased virtual prop prompt information.

16. The method according to claim 5, wherein a target interaction control corresponding to a virtual skill exists among the at least two interaction controls, and the method further comprises:
presenting, in the adding interface, a number switching control for switching a virtual skill number; and
in response to a trigger operation for the number switching control, switching a number of the target interaction control from a fourth number to a fifth number, the fourth number being not equal to the fifth number.

17. The method according to claim 5, wherein a target interaction control corresponding to a virtual skill exists among the at least two interaction controls, and the method further comprises:
presenting, in the adding interface, a number switching control for switching a virtual skill number; and
in response to a trigger operation for the number switching control, presenting clear prompt information, the clear prompt information being for prompting clearing of the received determining operation.

18. The method according to claim 5, wherein the method further comprises:
presenting a save control for saving the selection operation;
in response to a trigger operation for the save control, presenting a confirmation control for confirming the selection operation; and
in response to a trigger operation for the confirmation control, receiving a save instruction for the selection operation.

19. An apparatus for controlling opening operations in a virtual scene, comprising:
a memory operable to store computer-readable instructions; and
a processor circuitry operable to read the computer-readable instructions, the processor circuitry when executing the computer-readable instructions is configured to:
present a target virtual object and an opening control of the virtual scene, the opening control being associated with at least two opening operations, and the opening operations being interaction preparation operations before the target virtual object interacts with another virtual object;
in response to a trigger operation for the opening control, execute the at least two opening operations; and
in response to completion of execution of the at least two opening operations, cancel presentation of the opening control, and present a battle interface, the battle interface being for the target virtual object to interact with the another virtual object in a battle.

20. A non-transitory machine-readable media, having instructions stored on the machine-readable media, the instructions configured to, when executed, cause a machine to:
present a target virtual object and an opening control of the virtual scene, the opening control being associated with at least two opening operations, and the opening operations being interaction preparation operations before the target virtual object interacts with another virtual object;
in response to a trigger operation for the opening control, execute the at least two opening operations; and
in response to completion of execution of the at least two opening operations, cancel presentation of the opening control, and present a battle interface, the battle interface being for the target virtual object to interact with the another virtual object in a battle.
